(19) United States
(12) Patent Application Publication
(10) Pub. No.: US 2014/0050270 A1
(43) Pub. Date: Feb. 20, 2014

(54) METHOD FOR MANAGING A REFERENCE PICTURE LIST, AND APPARATUS USING SAME

(71) Applicants: Jaehyun Lim, Seoul (KR); Seungwook Park, Seoul (KR); Jungsun Kim, Seoul (KR); Joonyoung Park, Seoul (KR); Younghee Choi, Seoul (KR); Byeongmoon Jeon, Seoul (KR); Yongjoon Jeon, Seoul (KR)

(72) Inventors: Jaehyun Lim, Seoul (KR); Seungwook Park, Seoul (KR); Jungsun Kim, Seoul (KR); Joonyoung Park, Seoul (KR); Younghee Choi, Seoul (KR); Byeongmoon Jeon, Seoul (KR); Yongjoon Jeon, Seoul (KR)

(73) Assignee: LG Electronics Inc., Seoul (KR)

(21) Appl. No.: 14/114,012

(22) PCT Filed: Apr. 20, 2012
(86) PCT No.: PCT/KR2012/003094

§ 371 Date: Oct. 25, 2013

Related U.S. Application Data
(60) Provisional application No. 61/479,369, filed on Apr. 26, 2011.

(51) Int. Cl. H04N 7/26

(52) U.S. Cl. CPC H04N 19/00533
USPC 375/240.25

(57) ABSTRACT

Provided are a method for managing a reference picture list, and an apparatus using same. An image decoding method comprises the steps of decoding one picture of second-highest temporal layer pictures in a hierarchical picture configuration; and decoding top temporal layer pictures which precede and follow the second-highest temporal layer pictures with respect to a picture order count (POC) in a POC sequence, respectively. Therefore, available reference pictures remain in a decoded picture buffer (DPB), thereby improving image-encoding efficiency.

### TECHNICAL FIELD

The present invention relates to a video decoding method and a video decoder, and more particularly, to a method of managing a reference picture list and a device using the method.

### BACKGROUND ART

In recent years, demands for a high-resolution and high-quality video such as a high definition (HD) video and an ultra high definition (UHD) video have increased in various fields of applications. However, as a video has a higher resolution and higher quality, an amount of data of the video increases more than existing video data. Accordingly, when video data is transferred using media such as existing wired or wireless broadband lines or is stored in existing storage media, the transfer cost and the storage cost thereof increase. High-efficiency video compressing techniques can be used to solve such problems due to an enhancement in resolution and quality of video data.

Various techniques such as an inter prediction technique of predicting pixel values included in a current picture from a previous or subsequent picture of the current picture, an intra prediction technique of predicting pixel values included in a current picture using pixel information in the current picture, and an entropy coding technique of allocating a short code to a value of a low appearance frequency and allocating a long code of a value of a high appearance frequency are known as the video compressing techniques. It is possible to effectively compress, transfer, or store video data using such video compressing techniques.

### SUMMARY OF THE INVENTION

### Technical Problem

An object of the invention is to provide a method of managing a reference picture list so as to enhance video encoding/decoding efficiency.

Another object of the invention is to provide a device performing the method of managing a reference picture list so as to enhance video encoding/decoding efficiency.

### Solution to Problem

According to an aspect of the invention, there is provided a video decoding method including the steps of decoding one picture out of second highest temporal layer pictures in a hierarchical picture structure, and decoding a highest temporal layer picture present previously or subsequently in the order of picture order counts (POC) on the basis of the POC of the second highest temporal layer pictures. The video decoding method may further include the step of determining whether the number of pictures calculated on the basis of short-term reference pictures and long-term reference pictures stored in a DPB so as to include the decoded second highest temporal layer pictures is equal to Max(max_num_ref_frame, 1) and whether the number of short-term reference pictures is larger than 0. The video decoding method may further include the step of calculating the number of short-term reference pictures and the number of long-term reference pictures. The video decoding method may further include the step of removing the short-term reference picture having the smallest POC out of the short-term reference pictures present in the DPB from the DPB when the number of pictures stored in the DPB is equal to Max(max_num_ref_frame, 1) and the number of short-term reference pictures is larger than 0. The hierarchical picture structure may be a GOP hierarchical picture structure including five temporal layer pictures and eight pictures. The second highest temporal layer picture may be a picture present in a third temporal layer and the highest temporal layer picture may be a picture present in a fourth temporal layer.

According to another aspect of the invention, there is provided a video decoding method including the steps of determining whether the number of pictures calculated on the basis of short-term reference pictures and long-term reference pictures stored in a DPB so as to include decoded second highest temporal layer pictures is equal to Max(max_num_ref_frame, 1), and determining whether the number of short-term reference pictures is larger than 0. The video decoding method may further include the step of calculating the number of short-term reference pictures and the number of long-term reference pictures. The video decoding method may further include the step of removing the short-term reference picture having the smallest POC out of the short-term reference pictures present in the DPB from the DPB when the number of pictures stored in the DPB is equal to Max(max_num_ref_frame, 1) and the number of short-term reference pictures is larger than 0.

According to still another aspect of the invention, there is provided a video decoder including a picture information determining module that decodes one picture out of second highest temporal layer pictures in a hierarchical picture structure and determine picture information so as to decode a highest temporal layer picture present previously or subsequently in the order of picture order counts (POC) order on the basis of the POC of the second highest temporal layer pictures, and a reference picture storage module that stores the second highest temporal layer picture decoded on the basis of the picture information determined by the picture information determining module. The video decoder may further include a reference picture information updating module that determines whether the number of pictures calculated on the basis of short-term reference pictures and long-term reference pictures stored in the reference picture storage module so as to include the decoded second highest temporal layer pictures is equal to Max(max_num_ref_frame, 1) and whether the number of short-term reference pictures is larger than 0. The reference picture information updating module may calculate the number of short-term reference pictures and the number of long-term reference pictures. The reference picture information updating module may remove the short-term reference picture having the smallest POC out of the short-term reference pictures present in the reference picture storage module from the DPB when the number of pictures stored in the reference picture storage module is equal to Max(max_num_ref_frame, 1) and the number of short-term reference pictures is larger than 0. The hierarchical picture structure may be a GOP hierarchical picture structure including five temporal layer pictures and eight pictures. The second highest temporal layer picture may be a picture present in a third temporal layer and the highest temporal layer picture may be a picture present in a fourth temporal layer.

According to still another aspect of the invention, there is provided a video decoder including a reference picture information updating module that determines whether the number of pictures calculated on the basis of short-term reference pictures and long-term reference pictures stored in a reference picture storage module so as to include decoded second highest temporal layer pictures is equal to Max(max_num_ref_frame, 1) and determines whether the number of short-term reference pictures is larger than 0, and a reference picture storage module that updates the reference pictures on the basis of information created by the reference picture information updating unit The reference picture information updating module may calculate the number of short-term reference pictures and the number of long-term reference pictures. The reference picture information updating module may update the reference picture so as to remove the short-term reference picture having the smallest POC out of the short-term reference pictures present in the DPB from the DPB when the number of pictures stored in the DPB is equal to Max(max_num_ref_frame, 1) and the number of short-term reference pictures is larger than 0.

### Advantageous Effects

In the above-mentioned method of managing a reference picture list and the above-mentioned device using the method according to the aspects of the invention, it is possible to reduce the number of cases where an optimal reference pictures is not available and to enhance video encoding/decoding efficiency by changing the order of decoding reference pictures and changing the reference picture removing method applied to the DPB.

### BRIEF DESCRIPTION OF THE DRAWINGS

FIG. 1 is a block diagram schematically illustrating a video encoder according to an embodiment of the invention.

FIG. 2 is a block diagram schematically illustrating a video decoder according to an embodiment of the invention.

FIG. 3 is a conceptual diagram illustrating a hierarchical coding structure according to an embodiment of the invention.

FIG. 4 is a flowchart illustrating a decoding order determining method in a hierarchical picture structure according to an embodiment of the invention.

FIG. 5 is a flowchart illustrating a sliding window method according to an embodiment of the invention.

FIG. 6 is a flowchart illustrating a reference picture management method according to an embodiment of the invention.

FIG. 7 is a conceptual diagram illustrating a video decoder according to an embodiment of the invention.

### DESCRIPTION OF EXEMPLARY EMBODIMENTS

The invention may be modified in various forms and have various embodiments, and specific embodiments thereof will be described in detail with reference to the accompanying drawings. However, it should be understood that the invention is not limited to the specific embodiments and includes all modifications, equivalents, and substitutions included in the technical spirit and scope of the invention. In the drawings, like elements are referenced by like reference numerals.

Terms such as “first” and “second” can be used to describe various elements, but the elements are not limited to the terms. The terms are used only to distinguish one element from another element For example, without departing from the scope of the invention, a first element may be named a second element and the second element may be named the first element similarly. The term, “and/or”, includes a combination of plural relevant elements or any one of the plural relevant elements.

If it is mentioned that an element is “connected to” or “coupled to” another element, it should be understood that still another element may be interposed therebetween, as well as that the element may be connected or coupled directly to another element. On the contrary, if it is mentioned that an element is “connected directly to” or “coupled directly to” another element, it should be understood that still another element is not interposed therebetween.

The terms used in the following description are used to merely describe specific embodiments, but are not intended to limit the invention. An expression of the singular number includes an expression of the plural number, so long as it is clearly read differently. The terms such as “include” and “have” are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded.

Hereinafter, exemplary embodiments of the invention will be described in detail with reference to the accompanying drawings. Like elements in the drawings will be referenced by like reference numerals and will not be repeatedly described.

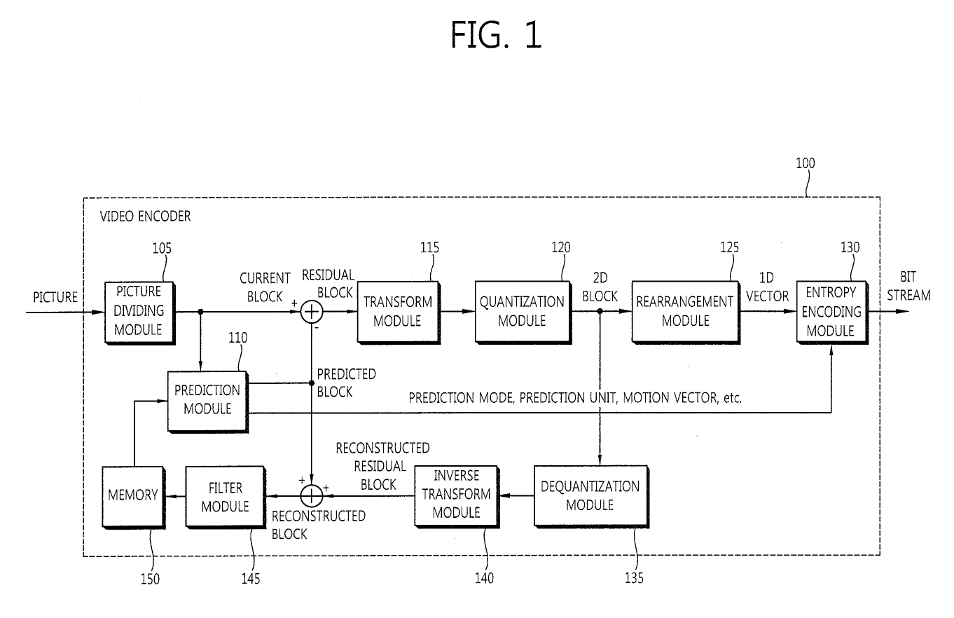

FIG. 1 is a block diagram illustrating a video encoder according to an embodiment of the invention.

Referring to FIG. 1, a video encoder 100 includes a picture dividing module 105, a prediction module 110, a transform module 115, a quantization module 120, a rearrangement module 125, an entropy encoding module 130, a dequantization module 135, an inverse transform module 140, a filter module 145, and a memory 150.

The elements in FIG. 1 are independently illustrated to represent different distinctive functions and do not mean that each element is not constructed by an independent hardware or software element. That is, the elements are independently arranged for the purpose of convenience for explanation and at least two elements may be combined into a single element or a single element may be divided into plural elements to perform the functions. Embodiments in which the elements are combined or divided are included in the scope of the invention without departing from the concept of the invention.

Some elements may not be essential elements used to perform essential functions of the invention but may be selective elements used to merely improve performance. The invention may be embodied by only elements essential to embody the invention, other than the elements used to merely improve performance, and a structure including only the essential elements other than the selective elements used to merely improve performance is included in the scope of the invention.

The picture dividing module 105 may divide an input picture into one or more process units. Here, the process unit may be a prediction unit (“PU”), a transform unit (“TU”), or a coding unit (“CU”). The picture dividing module 105 may divide one picture into combinations of plural coding units, prediction units, or transform units, and may encode a picture by selecting one combination of coding units, prediction units, or transform units with a predetermined reference (for example, cost function).

For example, one picture may be divided into plural coding units. A recursive tree structure such as quad tree structure can be used to divide a picture into coding units. Here, a coding unit which is divided into other coding units with a picture or a largest coding unit as a root may be divided with child nodes corresponding to the number of divided coding units. A coding unit which is not divided any more by a predetermined limitation serves as a leaf node. That is, when it is assumed that a coding unit cannot help being divided in a square shape, one coding unit can be divided into four other coding units at most.

In the embodiments of the invention, a coding unit may be used as a decoding unit as well as an encoding unit.

A prediction unit may be divided in at least one rectangular or square form having the same size in a single coding unit or may be divided so that one divided prediction unit in a single coding unit have a form different from the other divided prediction units.

When a prediction unit of which inter prediction is performed on the basis is not a least coding unit, the inter prediction may be performed without dividing the prediction unit into plural prediction units (N×N).

The prediction module 110 may include an inter prediction module that performs an inter prediction process and an intra prediction module that performs an intra prediction process. The prediction module may determine whether the inter prediction or the intra prediction will be performed on the prediction unit and may determine specific information (for example, an intra prediction mode, a motion vector, and a reference picture) depending on the prediction method. Here, the process unit subjected to the prediction process may be different from the process unit of which the prediction method and the specific information is determined. For example, the prediction method, the prediction mode, and the like may be determined in the units of PU and the prediction process may be performed in the units of TU. The prediction mode information, the motion vector information, and the like used for the prediction along with residual values may be encoded by the entropy encoding module 130 and may be transmitted to a decoder. When a specific encoding mode is used, a predicted block may not be constructed by the prediction module 110 but an original block may be encoded and transmitted to the decoder.

The inter prediction module may predict a prediction unit on the basis of information of at least one picture of a previous picture or a subsequent picture of a current picture. The inter prediction module may include a reference picture interpolating module, a motion estimating module, and a motion compensating module.

The reference picture interpolating module may be supplied with reference picture information from the memory 150 and may create pixel information of an integer pixel or less from the reference picture. In case of luma pixels, an 8-tap DCT-based interpolation filter having different filter coefficients may be used to create pixel information of an integer pixel or less in the units of ¼ pixels. In case of aroma pixels, a 4-tap DCT-based interpolation filter having different filter coefficients may be used to create pixel information of an integer pixel or less in the units of ⅛ pixels.

The motion estimating module may perform motion estimation on the basis of a reference picture interpolated by the reference picture interpolating module. Various methods such as an FBMA (Full search-based Block Matching Algorithm), a TSS (Three Step Search) algorithm, an NTS (New Three-Step Search Algorithm) may be used to calculate a motion vector. A motion vector may have a motion vector value in the units of ½ pixels or ¼ pixels on the basis of the interpolated pixels. The motion estimating module may predict a current prediction unit by changing the motion estimating method. Various methods such as a skip method, a merge method, and an AMVP (Advanced Motion Vector Prediction) method may be used as the motion prediction method.

In the embodiments of the invention described below, a method of constructing a candidate predicted motion vector list at the time of performing inter prediction using the AMVP method will be described.

The intra prediction module may construct a prediction unit on the basis of reference pixel information neighboring a current block which is pixel information in a current picture. When a neighboring block of the current prediction unit is a block subjected to the inter prediction and thus reference pixels are pixels subjected to the inter prediction, the reference pixels included in the block subjected to the inter prediction may be used instead of the reference pixel information of the neighboring block subjected to the intra prediction. That is, when a reference pixel is not available, unavailable reference pixel information may be replaced with at least one reference pixel of available reference pixels.

The prediction modes of the intra prediction may have directional prediction modes in which reference pixel information is used depending on the prediction direction and unidirectional prediction modes in which directionality information is not used to perform the prediction. A mode for predicting luma information may be different from a mode for predicting chroma information, and intra prediction mode information obtained by predicting luma information or predicted luma signal information may be used to predict the chroma information.

When the size of the prediction unit and the size of the transform unit are equal to each other at the time of performing the intra prediction, the intra prediction is performed on the prediction unit on the basis of pixels present on the left side of the prediction unit, a pixel present at the top-left corner, and pixels present on the top side. However, when the size of the prediction unit and the size of the transform unit are different from each other at the time of performing the intra prediction, the intra prediction may be performed using reference pixels based on the transform unit. The intra prediction using N×N division may be performed on only the least coding unit

In the intra prediction method, a predicted block may be constructed after applying an MDIS (Mode Dependent Intra Smoothing) filter to reference pixels depending on the prediction modes. The type of the MDIS filter applied to the reference pixels may vary. In order to perform the intra prediction method, an intra prediction mode of a current prediction unit may be predicted from the intra prediction mode of a prediction unit neighboring the current prediction unit. In predicting the prediction mode of the current prediction unit using mode information predicted from the neighboring prediction unit, information indicating that the prediction modes of the current prediction unit and the neighboring prediction unit are equal to each other may be transmitted using predetermined flag information when the intra prediction modes of the current prediction unit and the neighboring prediction unit are equal to each other, and entropy encoding may be performed to encode prediction mode information of the current prediction block when the prediction modes of the current prediction unit and the neighboring prediction unit are different from each other.

A residual block including residual information which is a difference between the prediction unit subjected to the prediction and the original block of the prediction unit may be constructed on the basis of the prediction unit created by the prediction module 110. The constructed residual block may be input to the transform module 115. The transform module 115 may transform the residual block including the residual information between the original block and the prediction unit created by the prediction module 110 using a transform method such as a DCT (Discrete Cosine Transform) or a DST (Discrete Sine Transform). On the basis of the intra prediction mode information of the prediction unit used to construct the residual block, it may be determined whether the DCT or the DST will be applied to transform the residual block

The quantization module 120 may quantize the values transformed to the frequency domain by the transform module 115. The quantization coefficients may vary depending on the block or the degree of importance of a video. The values calculated by the quantization module 120 may be supplied to the dequantization module 135 and the rearrangement module 125.

The rearrangement module 125 may rearrange the coefficients of the quantized residual values.

The rearrangement module 125 may change the quantization coefficients in the form of a two-dimensional block to the form of a one-dimensional vector through the use of a coefficient scanning method. For example, the rearrangement module 125 may scan from the DC coefficients to the coefficients in a high frequency domain using a zigzag scanning method and may change the coefficients to the form of a one-dimensional vector. A vertical scanning method of scanning the coefficients in the form of a two-dimensional block in the column direction and a horizontal scanning method of scanning the coefficients in the form of a two-dimensional block in the row direction may be used instead of the zigzag scanning method depending on the size of the transform unit and the intra prediction mode. That is, which of the zigzag scanning method, the vertical scanning method, and the horizontal scanning method to use may be determined depending on the size of the transform unit and the intra prediction mode.

The entropy encoding module 130 may perform entropy encoding on the basis of the values calculated by the rearrangement module 125. The entropy encoding may be performed using various encoding methods such as exponential Golomb, VLC (Variable Length Coding), and CABAC (Context-Adaptive Binary Arithmetic Coding).

The entropy encoding module 130 may encode a variety of information such as residual coefficient information and block type information of the coding unit, prediction mode information, division unit information, prediction unit information, transfer unit information, motion vector information, reference frame information, block interpolation information, and filtering information transmitted from the prediction module 110.

The entropy encoding module 130 may entropy-encode the coefficient values of the coding unit input from the rearrangement module 125.

The dequantization module 135 may dequantize the values quantized by the quantization module 120 and the inverse transform module 140 may inversely transform the values transformed by the transform module 115. The residual block constructed by the dequantization module 135 and the inverse transform module 140 is combined with the prediction unit predicted by the motion estimating module, the motion compensating module, and the intra prediction module of the prediction module 110 to construct a reconstructed block.

The filter module 145 may include at least one of a deblocking filter, an offset correcting module, and an ALF (Adaptive Loop Filter).

The deblocking filter 145 may remove block distortion generated at the boundary between blocks in the reconstructed picture. In order to determine whether to perform deblocking, it may be determined on the basis of pixels included in several columns or rows included in the block whether to apply the deblocking filter to the current block. When the deblocking filter is applied to the block, a strong filter or a weak filter may be applied depending on the necessary deblocking filtering strength. When vertical filtering and horizontal filtering are performed in applying the deblocking filter, the horizontal filtering and the vertical filtering may be carried out in parallel.

The offset correcting module may correct an offset of the picture subjected to the deblocking from the original picture by pixels. A method of partitioning pixels included in a picture into a predetermined number of areas, determining an area to be subjected to the offset, and applying the offset to the determined area or a method of applying the offset in consideration of edge information of the pixels may be used to perform the offset correction on a specific picture.

The ALF (Adaptive Loop Filter) may perform a filtering operation on the basis of values as the comparison result of the filtered reconstructed picture and the original picture. The pixels included in the picture may be partitioned into predetermined groups, filters to be applied to the groups may be determined, and the filtering operation may be individually performed for each group. Regarding information on whether to apply the ALF, a luma signal may be transmitted by coding units (CU) and the size and coefficients of the ALF to be applied may vary depending on the blocks. The ALF may have various forms and the number of coefficients included in the filter may accordingly vary. The information (such as filter coefficient information, ALF On/Off information, and filter type information) relevant to the filtering of the ALF may be included in a predetermined parameter set of a bitstream and then may be transmitted.

The memory 150 may store the reconstructed block or picture calculated through the filter module 145. The reconstructed block or picture stored in the memory may be supplied to the prediction module 110 at the time of performing the inter prediction.

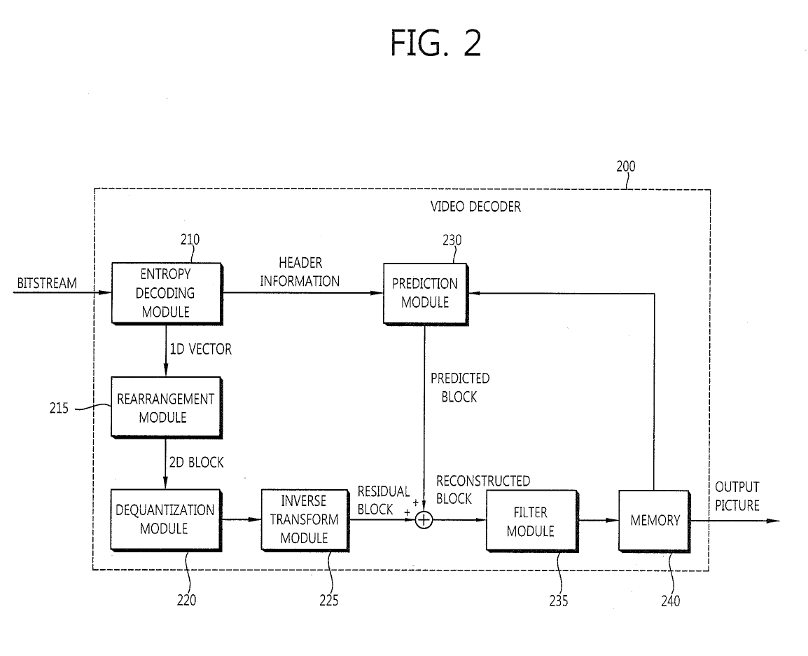

FIG. 2 is a block diagram illustrating a video decoder according to an embodiment of the invention.

Referring to FIG. 2, a video decoder 200 may include an entropy decoding module 210, a rearrangement module 215, a dequantization module 220, an inverse transform module 225, a prediction module 230, a filter module 235, and a memory 240.

When a video bitstream is input from the video encoder, the input bitstream may be decoded in the reverse order of the order in which the video information is processed by the video encoder.

The entropy encoding module 210 may perform entropy decoding in the reverse order of the order in which the entropy encoding module of the video encoder performs the entropy encoding, and the residual subjected to the entropy decoding by the entropy decoding module may be input to the rearrangement module 215.

The entropy decoding module 210 may decode information relevant to the intra prediction and the inter prediction performed by the video encoder. As described above, when a predetermined limitation is applied to the intra prediction and the inter prediction performed by the video encoder, the entropy decoding based on the limitation may be performed to acquire the information relevant to the intra prediction and the inter prediction on the current block

The rearrangement module 215 may rearrange the bitstream entropy-decoded by the entropy decoding module 210 on the basis of the rearrangement method used in the video encoder. The rearrangement module may reconstruct and rearrange the coefficients expressed in the form of a one-dimensional vector to the coefficients in the form of a two-dimensional block. The rearrangement module may perform rearrangement using a method of acquiring information relevant to the coefficient scanning performed in the video encoder and inversely scanning the coefficients on the basis of the scanning order performed by the video encoder.

The dequantization module 220 may perform dequantization on the basis of the quantization parameters supplied from the video encoder and the rearranged coefficient values of the block

The inverse transform module 225 may perform inverse DCT and inverse DST of the DCT and the DST performed by the transform module on the quantization result performed by the video encoder. The inverse transform may be performed on the basis of the transfer unit determined by the video encoder. The transform module of the video encoder may selectively perform the DCT and the DST depending on plural information pieces such as the prediction method, the size of the current block, and the prediction direction, and the inverse transform module 225 of the video decoder may perform the inverse transform on the basis of information on the transform performed by the transform module of the video encoder.

The transform may be performed on the basis of the coding unit instead of the transform unit.

The prediction module 230 may construct a predicted block on the basis of information relevant to predicted block construction supplied from the entropy decoding module 210 and previously-decoded block or picture information supplied from the memory 240.

When the size of the prediction unit and the size of the transform unit are equal to each other at the time of performing the intra prediction similarly to the operation of the video encoder as described above, the intra prediction is performed on the prediction unit on the basis of pixels located on the left side of the prediction unit, a pixel located at the top-left corner, and pixels located on the top side. However, when the size of the prediction unit and the size of the transform unit are different from each other at the time of performing the intra prediction, the intra prediction may be performed using the reference pixels based on the transform unit. The intra prediction using N×N division may be used for the smallest coding unit.

The prediction module 230 may include a prediction unit determining module, an inter prediction module, and an intra prediction module. The prediction unit determining module is supplied with a variety of information such as prediction unit information, prediction mode information of the intra prediction method, and information relevant to motion estimation of the inter prediction method from the entropy decoding module, divides the prediction unit in the current coding unit, and determines whether the inter prediction or the intra prediction will be performed on the prediction unit The inter prediction module may perform the inter prediction on the current prediction unit on the basis of information included in at least one picture of a previous picture and a subsequent picture of the current picture including the current prediction unit using the information necessary for the inter prediction of the current prediction unit supplied from the video encoder.

It may be determined which of the skip mode, the merge mode, and the AMVP mode is used as the prediction method of the prediction unit included in the coding unit on the basis of the coding unit so as to perform the inter prediction.

In embodiments of the invention, a method of constructing a candidate predicted motion vector list at the time of performing the inter prediction using the AMVP method will be described below.

The intra prediction module may construct a predicted block on the basis of pixel information of a current picture. When the prediction unit is a prediction unit subjected to the intra prediction, the intra prediction may be performed on the basis of the intra prediction mode information of the prediction unit supplied from the video encoder. The intra prediction module may include an MDIS filter, a reference pixel interpolating module, and a DC filter. The MDIS filter serves to perform a filtering operation on the reference pixels of the current block and may determine whether to apply a filter depending on the prediction mode of the current prediction unit. The MDIS filtering may be performed on the reference pixels of the current block using the prediction mode of the prediction unit supplied form the video encoder and the MDIS filter information. When the prediction mode of the current block is a mode not to be subjected to the MDIS filtering, the MDIS filter may not be applied.

When the prediction mode of the prediction unit is a prediction mode in which the intra prediction is performed on the basis of the pixel values obtained by interpolating the reference pixels, the reference pixel interpolating module may interpolate the reference pixels to create reference pixels of an integer pixel or less. When the prediction mode of the current prediction unit is a prediction mode in which a predicted block is constructed without interpolating the reference pixels, the reference pixels may not be interpolated. The DC filter may construct a predicted block through the filtering when the prediction mode of the current block is a DC mode.

The reconstructed block or picture may be supplied to the filter module 235. The filter module 235 may include a deblocking filter, an offset correcting module, and an ALF.

The filter module may be supplied with information on whether to apply the deblocking filter on the corresponding block or picture and information on which of a strong filter and a weak filter to apply when the deblocking filter is applied from the video encoder. The deblocking filter of the video decoder may be supplied with deblocking filter relevant information supplied from the video encoder and may perform the deblocking filtering on the corresponding block. Similarly to the video encoder, the vertical deblocking filtering and the horizontal deblocking filtering may be first performed and at least one of the vertical deblocking and the horizontal deblocking may be performed on the overlap part. The vertical deblocking filtering or the horizontal deblocking filtering not performed previous may be performed on the overlap portion in which the vertical deblocking filtering and the horizontal deblocking filtering overlap. The parallel deblocking filtering can be performed through this deblocking filtering process.

The offset correcting module may perform offset correction on the reconstructed picture on the basis of the type of the offset correction applied to the picture at the time of encoding the picture and the offset value information.

The ALF may perform a filtering operation on the basis of the comparison result of the reconstructed picture subjected to the filtering and the original picture. The ALF may be applied to the coding unit on the basis of information on whether the ALF has been applied and the ALF coefficient information supplied from the video encoder. The ALF relevant information may be supplied along with a specific parameter set.

The memory 240 may store the reconstructed picture or block for use as a reference picture or block, and may supply the reconstructed picture to an output module.

As described above, in the embodiments of the invention, the coding unit is used as a term representing an encoding unit for the purpose of convenience for explanation, but the coding unit may serve as a decoding unit as well as an encoding unit.

A video encoding method and a video decoding method to be described later in the embodiments of the invention may be performed by the constituent parts of the video encoder and the video decoder described with reference to FIGS. 1 and 2. The constituent parts may be constructed as hardware or may include software processing modules which can be performed in an algorithm.

The inter prediction module may perform the inter prediction of predicting pixel values of a prediction target block using information other reconstructed frames other than a current frame. A picture used for the prediction is referred to as a reference picture (or a reference frame). Inter prediction information used to predict a prediction target block may include reference picture index information indicating what reference picture to use and motion vector information indicating a vector between a block of the reference picture and the prediction target block

A reference picture list may be constructed by pictures used for the inter prediction of a prediction target block. In case of a B slice, two reference picture lists are necessary for performing the prediction. In the following embodiments of the invention, the two reference picture lists may be referred to as a first reference picture list (List 0) and a second reference picture list (List 1). A B slice of which the first reference picture list (reference list 0) and the second reference picture list (reference list 1) are equal may be referred to as a GPB slice.

Table 1 represents a syntax element relevant to reference picture information included in an upper-level syntax. A syntax element used in the embodiments of the invention and an upper-level syntax (SPS) including the syntax element are arbitrary and the syntax elements may be defined to be different with the same meaning. The upper-level syntax including the syntax element may be included in another upper-level syntax (for example, syntax or PPS in which only reference picture information is separately included). A specific case will be described below in the embodiments of the invention, but the expression form of the syntax elements and the syntax structure including the syntax elements may diversify and such embodiments are included in the scope of the invention.

TABLE 1

| seq_parameter_set_rbsp( ) { | Descriptor |
|---|---|
| . | |
| . | |
| . | |
| max_num_ref_frames | ue(v) |
| . | |
| . | |
| . | |
| } | |

Referring to Table 1, an upper-level syntax such as an SPS (Sequence Parameter Set) may include information associated with a reference picture used for the inter prediction.

Here, max_num_ref_frames represents the maximum number of reference pictures which can be stored in a DPB (Decoded Picture Buffer). When the number of reference pixels currently stored in the DPB is equal to the number of reference pictures set in max_num_ref_frames, the DPB has no space for storing an additional reference picture. Accordingly, when an additional reference picture has to be stored, one reference picture out of the reference pictures stored in the DPB should be removed from the DPB.

A syntax element such as adaptive_ref_pic_marking_mode_flag included in a slice header may be referred to in order to determine what reference picture should be removed from the DPB.

Here, adaptive_ref_pic_marking_mode_flag is information for determining a reference picture to be removed from the DPB. When adaptive_ref_pic_marking_mode_flag is 1, additional information on what reference picture to remove may be transmitted to remove the specified reference picture from the DPB. When adaptive_ref_pic_marking_mode_flag is 0, one reference picture out of the reference pictures stored in the DPB may be removed from the DPB, for example, in the order in which pictures are decoded and stored in the DPB using a sliding window method. The following method may be used as the method of removing a reference picture using the sliding window.

(1) First, numShortTerm is defined as the total number of reference frames marked by “short-term reference picture” and numLongTerm is defined as the total number of reference frames marked by “long-term reference pictures”.

When the sum of the number of short-term reference pictures (numShortTerm) and the number of long-term reference pictures (numLongTerm) is equal to Max(max_num_ref frames, 1) and the condition that the number of short-term reference pictures is larger than 0 is satisfied, a short-term reference picture having the smallest value of FrameNumWrap is marked by “unavailable as reference picture”.

That is, in the above-mentioned sliding window method, the reference picture first decoded out of the short-term reference picture stored in the DPB may be removed.

According to an embodiment of the invention, when pictures are encoded and decoded with a hierarchical picture structure, pictures other than a picture having the highest temporal level may be used as reference pictures. When the pictures includes a B slice, predicted values of a block included in the B slice can be created using at least one reference picture list of list L0 and list L1. The number of reference pictures which are included in list L0 and list l1 and which can be used as the reference pictures may be restricted due to a problem in memory bandwidth.

When the maximum number of reference frames set in the max_num_ref_frames which is a syntax element indicating the maximum number of reference frames capable of being stored in the DPB is sufficiently larger, the number of reference pictures stored in the DPB increases and thus most of the reference pictures for constructing a prediction target block are available. However, as the resolution of a video increases and the amount of necessary memory increases, max_num_ref_frames is restricted, necessary reference pictures may be removed from the DPB, pictures to be used as the reference pictures may not be stored, and thus the reference pictures may not be used for the inter prediction. When the reference pictures are not stored in the DPB, the prediction accuracy of a predicted block may be lowered and the encoding efficiency may be lowered due this problem. In the reference picture managing method according to the embodiment of the invention, a setting method of making a reference picture to be referred to by a prediction target block available at the time of performing the inter prediction by reducing the number of cases where the reference pictures are not stored in the DPB and are unavailable will be described.

When an optimal reference picture to be used as a reference picture in the hierarchical picture structure is not stored in the DPB, another picture may be used as a reference picture, which may lower the encoding efficiency. In the following embodiments of the invention, a case where an optimal reference picture is not stored in the DPB is defined as a case where a reference picture is unavailable for the purpose of convenience for explanation, and includes a case where the optimal reference picture is not available and thus a second-optimal reference picture is used for the inter prediction.

In the following embodiments of the invention, for the purpose of convenience for explanation, it is assumed that max_num_ref_frames indicating the maximum number of reference pictures allowable in the DPB is 4, the maximum number of reference pictures (num_ref_idx_l0_active_minus1) which may be included in list L0 is 1, the maximum number of reference pictures (num_ref_idx_l1_active_minus1) which may be included in list L1 is 1, and num_ref_idx_lc_active_minus1 is 3. That is, the maximum number of reference pictures allowable in the DPB is 4, the maximum number of reference pictures which may be included in list L0 is 2, the maximum number of reference pictures which may be included in list L1 is 2, and the maximum number of reference pictures which may be included in list LC is 4.

List LC is a combination list and indicates a reference picture list constructed by combination of list L1 and list L0. List LC is a list which can be used to perform the inter prediction on a prediction target block using an unidirectional prediction method. ref_pic_list_combination_flag may represent the use of list LC when ref_pic_list_combination flag is 1, and may represent the use of GPB (Generalized B) when ref_pic_list_combination_flag is 0. The GPB represents a picture list in which list L0 and list L1 which are reference pictures list used to perform the prediction have the same picture as described above.

In the embodiments of the invention, it is assumed that the GOP (Group Of Pictures) structure is 8, but the number of pictures constituting the GOP may vary and such embodiments are included in the scope of the invention.

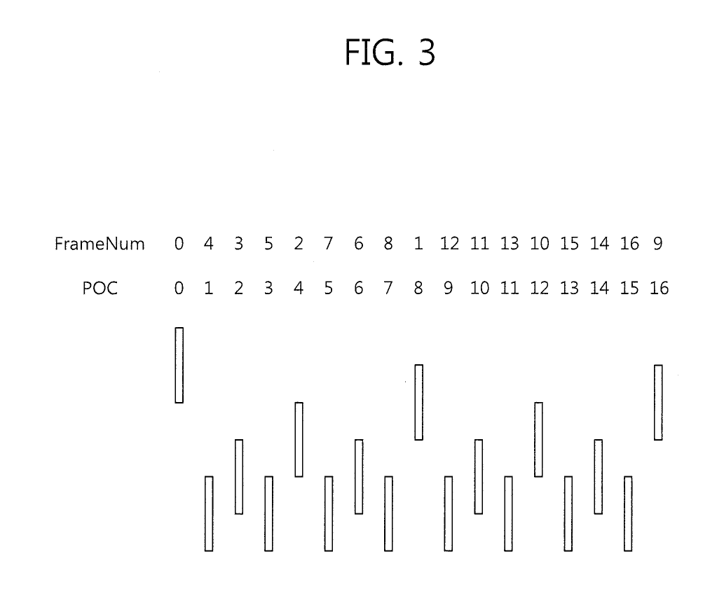

FIG. 3 is a conceptual diagram illustrating a hierarchical picture structure according to an embodiment of the invention.

Referring to FIG. 3, the POC (Picture Order Count) of pictures included in the GOP represents the display order of pictures, and FrameNum represents the encoding/decoding order of pictures. In the hierarchical encoding structure, pictures present in temporal layers other than the temporal layer in which the POC having the highest temporal level is 1, 3, 5, 7, 9, 11, 13, and 15 may be used as reference pictures.

According to an embodiment of the invention, the encoding/decoding order of pictures in the hierarchical picture structure may be changed to reduce the number of unavailable reference pictures and to increase the number of available reference pictures as much as possible.

The hierarchical picture structure may be defined on the basis of temporal layers of pictures.

When an arbitrary picture refers to a specific picture, the arbitrary picture may be includes in a temporal layer higher than the specific picture referred to.

In FIG. 3, a zeroth temporal layer corresponds to POC(0), a first temporal layer corresponds to POC(8) and POC(16), a second temporal layer corresponds to POC(4) and POC(12), a third temporal layer corresponds to POC(2), POC(6), POC(10), and POC(14), and a fourth temporal layer corresponds to POC(1), POC(3), POC(5), POC(7), POC(9), POC(11), POC(13), and POC(15).

According to the embodiment of the invention, by newly setting the decoding order (FrameNum) of pictures present in the fourth temporal layer (POC(1), POC(3), POC(5), POC(7), POC(9), POC(11), POC(13), POC(15)) which is the highest temporal level and reference pictures having the temporal levels (POC(2), POC(6), POC(10), POC(14)) present in the third temporal layer which is the second highest layer, the number of available reference pictures may be increased to be larger than that in the existing hierarchical picture structure.

In changing the decoding order (FrameNum), one picture of the second highest temporal layer in the hierarchical picture structure may be first decoded and then the pictures present in the highest temporal layer which is previous or subsequent to the second highest temporal layer in the POC sequence may be sequentially decoded. That is, by decoding the pictures of the highest temporal layer present around the decoded second highest temporal layer picture earlier than the pictures present in the other second highest temporal layer and having a POC larger than that of the decoded second highest temporal layer picture, it is possible to change the decoding order of the hierarchical picture structure.

Referring to FIG. 3, in the hierarchical picture structure including the zeroth temporal layer to the fourth temporal layer, one picture of the third temporal layer pictures is first decoded and then the picture present in the fourth temporal layer previous or subsequent to the third temporal layer picture in the POC sequence may be decoded earlier than the other third temporal layer pictures. For example, by changing the order of the step of decoding the reference pictures present in the highest temporal layer and the step of decoding the reference pictures present in the second highest temporal layer using the method of decoding the third temporal layer picture of POC(2) and then sequentially decoding the picture of POC(1) and the picture of POC(3) out of the fourth temporal layer pictures present around the picture of POC(2), it is possible to increase the number of cases where the pictures stored in the DPB become available reference pictures.

Table 2 shows the POCs of the reference pictures to be used in lists L0, L1, and LC with respect to the POC of the pictures illustrated in FIG. 3 and the pictures stored in the DPB on the basis of the hierarchical picture structure. In the DPB, at least one picture out of the reference pictures stored in the DPB may be removed using the above-mentioned sliding window method.

TABLE 2

| | | | | reference | | | |
|---|---|---|---|---|---|---|---|
| | | | | picture | | | |
| | required reference picture | | | availability | | | |
| POC | L0 | L1 | LC | L0 | L1 | LC | DPB |
| 0 | | | | | | | |
| 8 | 0 | 0 | 0 | ◯ | ◯ | ◯ | 0 |
| 4 | 0 8 | 8 0 | 0 8 | ◯ | ◯ | ◯ | 0 8 |
| 2 | 0 4 | 4 8 | 0 4 8 | ◯ | ◯ | ◯ | 0 8 4 |
| 1 | 0 2 | 2 4 | 0 2 4 | ◯ | ◯ | ◯ | 0 8 4 2 |
| 3 | 2 0 | 4 8 | 2 4 0 8 | ◯ | ◯ | ◯ | 0 8 4 2 |
| 6 | 4 2 | 8 4 | 4 8 2 | ◯ | ◯ | ◯ | 0 8 4 2 |
| 5 | 4 2 | 6 8 | 4 6 2 8 | ◯ | ◯ | ◯ | 8 4 2 6 |
| 7 | 6 4 | 8 6 | 6 8 4 | ◯ | ◯ | ◯ | 8 4 2 6 |
| 16 | 8 6 4 2 | 8 6 4 2 | 8 6 4 2 | ◯ | ◯ | ◯ | 8 4 2 6 |
| 12 | 8 6 | 16 8 | 8 16 6 | X | X | X | 4 2 6 16 |
| 10 | 8 6 | 12 16 | 8 12 6 16 | X | ◯ | X | 2 6 16 12 |
| 9 | 8 6 | 10 12 | 8 10 6 12 | X | ◯ | X | 6 16 12 10 |
| 11 | 10 8 | 12 16 | 10 12 8 16 | X | ◯ | X | 6 16 12 10 |
| 14 | 12 10 | 16 12 | 12 16 10 | ◯ | ◯ | ◯ | 6 16 12 10 |
| 13 | 12 10 | 14 16 | 12 14 10 16 | ◯ | ◯ | ◯ | 16 12 10 14 |
| 15 | 14 12 | 16 14 | 14 16 12 | ◯ | ◯ | ◯ | 16 12 10 14 |

Referring to Table 2, When the POC number is 0 to 16 and the POC number is 11 to 15, the reference pictures necessary for list L0, the reference pictures necessary for list L1, and the reference pictures necessary for list LC are all stored in the DPB, and thus all the reference pictures are available at the time of performing the inter prediction on the pictures of the POCs.

For example, in case of POC(1), list L0 may preferentially include POC(0) present on the left side of POC(1) and having a temporal layer lower than POC(1) and may include POC(2) present on the right side of POC(1) and having a temporal layer lower than POC(1). List L1 may preferentially include POC(2) present on the first left side of POC(1) and having a temporal layer lower than POC(1) and may include POC(4) present on the second right side of POC(1) and having a temporal layer lower than POC(1).

Since POC(0), POC(8), POC(2), and POC(4) are stored in the DPB, all the reference pictures of POC(0), POC(2), and POC(4) for predicting POC(1) are included and thus all the reference pictures for predicting POC(1) are available.

In FIG. 3, POC(12), POC(10), POC(9), and POC(11), reference pictures are unavailable four times for L0 prediction, reference pictures are unavailable once for L1 prediction, and reference pictures are unavailable four times for LC prediction, but the number of cases where the reference pictures are unavailable is reduced to enhance the encoding/decoding efficiency in comparison with the FrameNum allocating method used in the hierarchical picture structure.

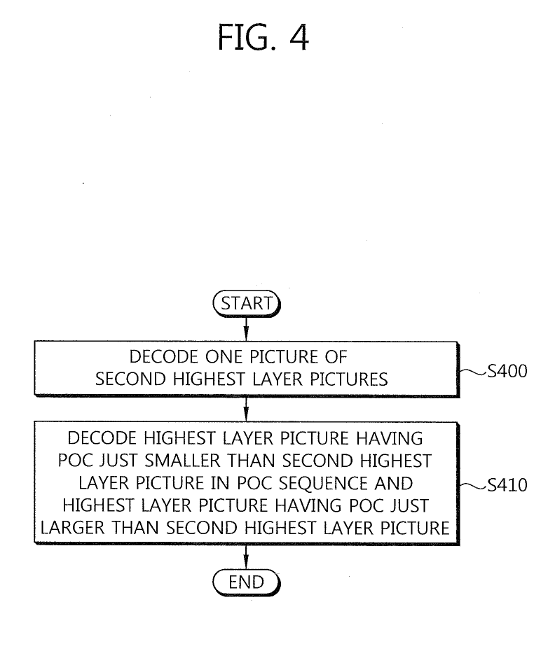

FIG. 4 is a flowchart illustrating a decoding order determining method in a hierarchical picture structure according to an embodiment of the invention.

Referring to FIG. 4, one picture of the second highest layer pictures is decoded (step S400).

Then, a highest layer picture having a POC just smaller than the POC of the second highest layer picture and a highest layer picture having a POC just larger than the POC of the second highest layer picture are decoded (step S410).

According to an embodiment of the invention, a second highest layer picture is decoded and stored in the DPB and then a highest layer picture referring to the second highest layer out of the reference pictures present in the highest layer is decoded. That is, an arbitrary second highest layer picture is decoded, a highest layer picture referring to the arbitrary second highest layer picture is then decoded, and then a highest layer picture having a POC larger than that of the arbitrary second highest layer picture is then decoded.

When the second highest layer picture is POC(n), the highest layer picture to be decoded in the next may be POC(n−1) and POC(n+1).

According to another embodiment of the invention, it is possible to enhance availability of reference pictures by applying the sliding window method differently for the reference pictures present in the DPB in the hierarchical structure.

The new sliding window method may be applied in the following way.

(1) First, numShortTerm is defined as the total number of reference frames marked by “short-term reference picture” and numLongTerm is defined as the total number of reference frames marked by “long-term reference picture”.

(2) When the sum of numShortTerm and numLongTerm is Max(max_num_ref_frame, 1) and numShortTerm is larger than 0, a short-term reference picture having the smallest value of PicOrderCnt(entryShortTerm) is marked by “unavailable as reference picture”.

That is, according to the embodiment of the invention, it is possible to manage the reference pictures stored in the DPB using the sliding window method of removing a picture having the smallest POC value out of the pictures which can be stored in the DPB from the DPB.

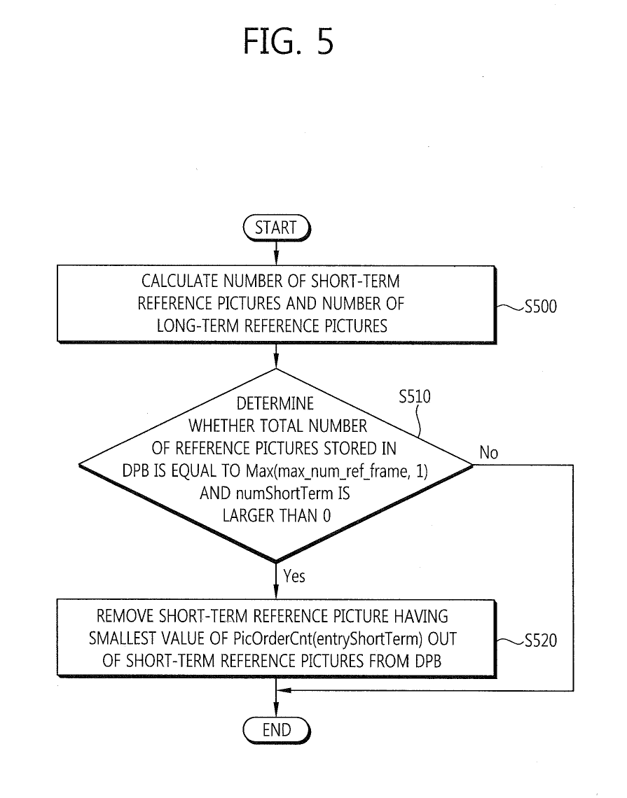

FIG. 5 is a flowchart illustrating the sliding window method according to the embodiment of the invention.

Referring to FIG. 5, the number of short-term reference pictures and the number of long-term reference pictures are calculated (step S500).

In order to calculate the total number of reference pictures stored in the DPB, the number of reference frames marked by the short-term reference picture is calculated and the number of reference frames marked by the long-term reference picture is calculated.

On the basis of the pictures stored in the DPB, it is determined whether the calculate number is equal to Max(max_num_ref_frame, 1) and numShortTerm is larger than 0 (step S510).

In step S510, two determination details on (1) whether the total number of pictures of the number of short-term reference pictures and the number of long-term reference pictures stored in the DPB so as to include the decoded pictures is equal to Max(max_num_ref_frame, 1) and (2) whether numShortTerm is larger than 0 may be performed in individual determination processes or in a single determination process.

It is possible to determine whether to remove a picture from the DPB by determining whether the total number of reference pictures is equal to Max(max_num_ref_frame, 1) and numShortTerm is larger than 0 on the basis of the pictures stored in the DPB. When the total number of reference pictures is equal to Max(max_num_ref_frame, 1) and numShortTerm is larger than 0, it means that the number of pictures currently stored in the DPB is equal to or more than the allowable maximum number of reference pictures. When numShortTerm is larger than 0, it means that at least one short-term reference picture is present

When the total number of reference pictures is equal to Max(max_num_ref_frame, 1) and numShortTerm is larger than 0, a short-term reference picture having the smallest value of PicOrderCnt(entryShortTerm), that is, having the smallest value of POC, out of the short-term reference pictures stored in the DPB is removed from the DPB (step S520).

When the total number of reference pictures is not equal to Max(max_num_ref_frame, 1) and numShortTerm is not larger than 0 on the basis of the pictures stored in the DPB, no picture is removed from the DPB.

Table 3 shows availability of reference pictures depending on the POC when the new sliding window method according to the embodiment of the invention is used.

TABLE 3

| | | | | reference | | | |
|---|---|---|---|---|---|---|---|
| | | | | picture | | | |
| | required reference picture | | | availability | | | |
| POC | L0 | L1 | LC | L0 | L1 | LC | DPB |
| 0 | | | | | | | |
| 8 | 0 | 0 | 0 | ◯ | ◯ | ◯ | 0 |
| 4 | 0 8 | 8 0 | 0 8 | ◯ | ◯ | ◯ | 0 8 |
| 2 | 0 4 | 4 8 | 0 4 8 | ◯ | ◯ | ◯ | 0 8 4 |
| 6 | 4 2 | 8 4 | 4 8 2 | ◯ | ◯ | ◯ | 0 8 4 2 |
| 1 | 0 2 | 2 4 | 0 2 4 | X | ◯ | X | 8 4 2 6 |
| 3 | 2 0 | 4 6 | 2 4 0 6 | X | ◯ | X | 8 4 2 6 |
| 5 | 4 2 | 6 8 | 4 6 2 8 | ◯ | ◯ | ◯ | 8 4 2 6 |
| 7 | 6 4 | 8 6 | 6 8 4 | ◯ | ◯ | ◯ | 8 4 2 6 |
| 16 | 8 6 4 2 | 8 6 4 2 | 8 6 4 2 | ◯ | ◯ | ◯ | 8 4 2 6 |
| 12 | 8 6 | 16 8 | 8 16 6 | ◯ | ◯ | ◯ | 8 4 6 16 |
| 10 | 8 6 | 12 16 | 8 12 6 16 | ◯ | ◯ | ◯ | 8 6 16 12 |
| 14 | 12 10 | 16 12 | 12 16 10 | ◯ | ◯ | ◯ | 8 16 12 10 |
| 9 | 8 6 | 10 12 | 8 10 6 12 | X | ◯ | X | 16 12 10 14 |
| n | 10 8 | 12 14 | 10 12 8 14 | X | ◯ | X | 16 12 10 14 |
| 13 | 12 10 | 14 16 | 12 14 10 16 | ◯ | ◯ | ◯ | 16 12 10 14 |
| 15 | 14 12 | 16 14 | 14 16 12 | ◯ | ◯ | ◯ | 16 12 10 14 |

Referring to Table 3, in case of POC(6), the number of pictures stored in the DPB is four (POC(0), POC(8), POC(4), and POC(2)). When POC(6) is additionally decoded, POC(0) corresponding to the smallest POC is removed from the DPB, whereby the DPB includes POC(8), POC(4), POC(2), and POC(6).

That is, in the embodiment of the invention, when the reference pictures stored in the DPB include frames of the number corresponding to max(max_num_ref_flame, 1), a reference picture having the smallest value of POC out of the POCs is removed from the DPB.

Referring to Table 3, in POC(1), POC(3), POC(9), and POC(11), since list L0 is unavailable four times and list L1 is unavailable four times, the number of cases where the reference pictures are unavailable is reduced in comparison with a case where the existing hierarchical picture structure is used, by using such a DPB managing method.

According to another embodiment of the invention, the method described with reference to FIGS. 4 and 5 may be used together.

That is, according to the embodiment of the invention, the method of rearranging FrameNum in the hierarchical picture structure illustrated in FIG. 4 and the new sliding window method illustrated in FIG. 5 may be simultaneously applied.

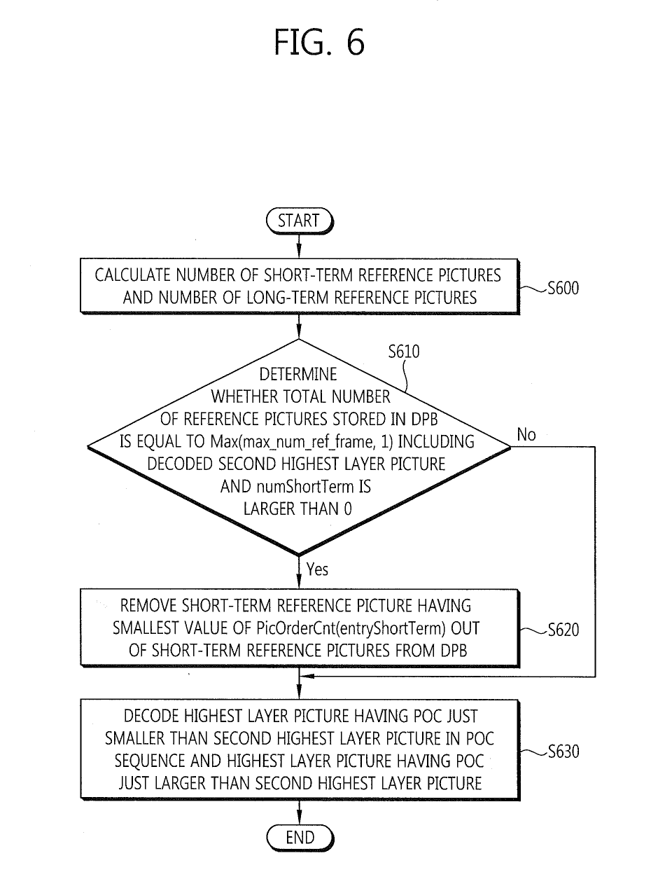

FIG. 6 is a flowchart illustrating a reference picture managing method according to an embodiment of the invention.

The simultaneous use of the method illustrated in FIG. 4 and the method illustrated in FIG. 5 will be described with reference to FIG. 6.

One picture of second highest layer pictures is decoded (step S600).

It is determined whether the total number of reference pictures of the short-term reference pictures and the long-term reference pictures stored in the DPB so as to include the decoded pictures is equal to Max(max_num_ref_frame, 1) and numShortTerm is larger than 0 (step S610).

In the determination step of step S610, two determination details on (1) whether the total number of pictures of the number of short-term reference pictures and the number of long-term reference pictures stored in the DPB so as to include the decoded pictures is equal to Max(max_num_ref_frame, 1) and (2) whether numShortTerm is larger than 0 may be performed in individual determination processes or in a single determination process.

When the total number of reference pictures stored in the DPB is equal to Max(max_num_ref_frame, 1) and numShortTerm is larger than 0, a short-term reference picture having the smallest value of PicOrderCnt(entryShortTerm), that is, having the smallest value of POC, out of the short-term reference pictures stored in the DPB is removed from the DPB (step S620).

When the number of reference pictures stored in the DPB is not equal to Max(max_num_ref_frame, 1) or numShortTerm is not larger than 0, no picture is removed from the DPB.

An upper layer picture having a POC just smaller than the POC sequence of the second highest layer picture and a POC just larger than the POC sequence of the second highest layer picture is decoded (step S630).

Since a highest layer picture is not stored as a reference picture, the process of managing reference pictures stored in the DPB may not be performed

Table 4 shows availability of reference pictures stored in the DPB and availability of pictures included in list L0 and list L1 when the method illustrated in FIG. 3 and the method shown in Table 3 are applied together.

TABLE 4

| | | | | reference | | | |
|---|---|---|---|---|---|---|---|
| | | | | picture | | | |
| | required reference picture | | | availability | | | |
| POC | L0 | L1 | LC | L0 | L1 | LC | DPB |
| 0 | | | | | | | |
| 8 | 0 | 0 | 0 | ◯ | ◯ | ◯ | 0 |
| 4 | 0 8 | 8 0 | 0 8 | ◯ | ◯ | ◯ | 0 |
| 2 | 0 4 | 4 8 | 0 4 8 | ◯ | ◯ | ◯ | 0 8 |
| 1 | 0 2 | 2 4 | 0 2 4 | ◯ | ◯ | ◯ | 0 8 4 |
| 3 | 2 0 | 4 8 | 2 4 0 8 | ◯ | ◯ | ◯ | 0 8 4 2 |
| 6 | 4 2 | 8 4 | 4 8 2 | ◯ | ◯ | ◯ | 0 8 4 2 |
| 5 | 4 2 | 6 8 | 4 6 2 8 | ◯ | ◯ | ◯ | 8 4 2 6 |
| 7 | 6 4 | 8 6 | 6 8 4 | ◯ | ◯ | ◯ | 8 4 2 6 |
| 16 | 8 6 4 2 | 8 6 4 2 | 8 6 4 2 | ◯ | ◯ | ◯ | 8 4 2 6 |
| 12 | 8 6 | 16 8 | 8 16 6 | ◯ | ◯ | ◯ | 8 4 6 16 |
| 10 | 8 6 | 12 16 | 8 12 6 16 | ◯ | ◯ | ◯ | 8 6 16 12 |
| 9 | 8 6 | 10 12 | 8 10 6 12 | X | ◯ | X | 8 16 12 10 |
| 11 | 10 8 | 12 16 | 10 12 8 16 | ◯ | ◯ | ◯ | 8 16 12 10 |
| 14 | 12 10 | 16 12 | 12 16 10 | ◯ | ◯ | ◯ | 8 16 12 10 |
| 13 | 12 10 | 14 16 | 12 14 10 16 | ◯ | ◯ | ◯ | 16 12 10 14 |
| 15 | 14 12 | 16 14 | 14 16 12 | ◯ | ◯ | ◯ | 16 12 10 14 |

Referring to Table 4, in POC(9), since reference pictures are unavailable once for the prediction using list L0 and reference pictures are unavailable once for the prediction using list LC, unavailability of reference pictures is reduced in comparison with the existing hierarchical picture structure.

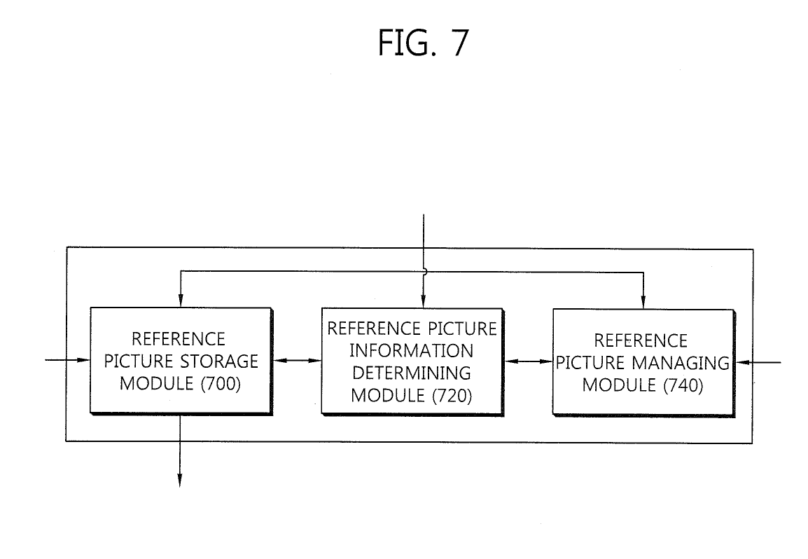

FIG. 7 is a conceptual diagram illustrating a video decoder according to an embodiment of the invention.

Referring to FIG. 7, a DPB of the video decoder include a reference picture storage module 700, a reference picture information determining module 720, and a reference picture managing module 740.

The elements may be independently arranged for the purpose of convenience for explanation and at least two elements may be combined into a single element or a single element may be divided into plural elements to perform the functions. Embodiments in which the elements are combined or divided are included in the scope of the invention without departing from the concept of the invention.

Some elements may not be essential elements used to perform essential functions of the invention but may be selective elements used to merely improve performance. The invention may be embodied by only elements essential to embody the invention, other than the elements used to merely improve performance, and a structure including only the essential elements other than the selective elements used to merely improve performance is also included in the scope of the invention.

For example, in the following embodiment of the invention, the reference picture storage module 700, the picture information determining module 720, and the reference picture information updating module 740 are described to be independent, but a module including at least one element of the reference picture storage module 700, the picture information determining module 720, and the reference picture information updating module 740 may be expressed by a term of DPB or memory.

The reference picture storage module 700 may store short-term reference pictures and long-term reference pictures. The short-term reference pictures and the long-term reference pictures may be differently stored in and removed from the reference picture storage module. For example, the short-term reference pictures and the long-term reference pictures may be differently stored and managed in the memory. For example, the short-term reference pictures may be managed in a FIFO way (First In First Out) in the memory. Regarding the long-term reference pictures, a reference picture not suitable for being opened in the FIFO way may be marked and used as a long-term reference picture.

The picture information determining module 720 may determine picture information such as POC and FrameNum in the hierarchical picture structure and may include picture information to be referred to and sequential picture information to be decoded.

The picture information determining module 720 may determine the picture information and may store the picture information in the reference picture storage module 700 so as to decode one picture of second highest temporal layer pictures on the basis of the hierarchical picture structure and then to decode highest temporal layer pictures previous and subsequent to the second highest temporal layer picture in the POC (Picture Order Count) sequence.

The reference picture information updating module 740 may also decode the hierarchical picture structure information, the GOP structure information, and the like and may determine picture information to be stored in the reference picture storage module 700.

The reference picture information updating module 740 may determine whether the number of pictures calculated on the basis of short-term reference pictures and long-term reference pictures stored in the DPB so as to include the decoded second highest temporal layer pictures is equal to Max(max_num_ref_frame, 1) and whether numShortTerm is larger than 0. When it is determined as the determination result that the number of pictures stored in the reference picture storage module 700 is equal to Max(max_num_ref_frame, 1) and numShortTerm is larger than 0, the short-term reference picture having the smallest POC out of the short-term reference pictures present in the DPB may be removed from the reference picture storage module.

The video encoding and decoding method described above can be embodied by the elements of the video encoder and the video decoder described with reference to FIGS. 1 and 2.

While the invention has been described with reference to the embodiments, it can be understood by those skilled in the art that the invention can be modified in various forms without departing from the technical spirit and scope of the invention described in the appended claims.

1. A video decoding method comprising the steps of:
decoding one picture out of second highest temporal layer pictures in a hierarchical picture structure; and
decoding a highest temporal layer picture present previously or subsequently in the order of picture order counts (POC) on the basis of the POC of the second highest temporal layer pictures.

2. The video decoding method according to claim 1, further comprising the step:
determining whether the number of pictures calculated on the basis of short-term reference pictures and long-term reference pictures stored in a DPB so as to include the decoded second highest temporal layer pictures is equal to Max(max_num_ref_frame, 1) and whether the number of short-term reference pictures is larger than 0.

3. The video decoding method according to claim 2, further comprising the step of
calculating the number of short-term reference pictures and the number of long-term reference pictures.

4. The video decoding method according to claim 2, further comprising the step of
removing the short-term reference picture having the smallest POC out of the short-term reference pictures present in the DPB from the DPB when the number of pictures stored in the DPB is equal to Max(max_num_ref_frame, 1) and the number of short-term reference pictures is larger than 0.

5. The video decoding method according to claim 1, wherein the hierarchical picture structure is a GOP hierarchical picture structure including five temporal layer pictures and eight pictures.

6. The video decoding method according to claim 1, wherein the second highest temporal layer picture is a picture present in a third temporal layer and the highest temporal layer picture is a picture present in a fourth temporal layer.

7. A video decoding method comprising the steps of:
determining whether the number of pictures calculated on the basis of short-term reference pictures and long-term reference pictures stored in a DPB so as to include decoded second highest temporal layer pictures is equal to Max(max_num_ref_frame, 1); and
determining whether the number of short-term reference pictures is larger than 0.

8. The video decoding method according to claim 7, further comprising the step of calculating the number of short-term reference pictures and the number of long-term reference pictures.

9. The video decoding method according to claim 7, further comprising the step of
removing the short-term reference picture having the smallest POC out of the short-term reference pictures present in the DPB from the DPB when the number of pictures stored in the DPB is equal to Max(max_num_ref_frame, 1) and the number of short-term reference pictures is larger than 0.

10. A video decoder comprising:
a picture information determining module that decodes one picture out of second highest temporal layer pictures in a hierarchical picture structure and determine picture information so as to decode a highest temporal layer picture present previously or subsequently in the order of picture order counts (POC) order on the basis of the POC of the second highest temporal layer pictures; and
a reference picture storage module that stores the second highest temporal layer picture decoded on the basis of the picture information determined by the picture information determining module.

11. The video decoder according to claim 10, further comprising:
a reference picture information updating module that determines whether the number of pictures calculated on the basis of short-term reference pictures and long-term reference pictures stored in the reference picture storage module so as to include the decoded second highest temporal layer pictures is equal to Max(max_num_ref_frame, 1) and whether the number of short-term reference pictures is larger than 0.

12. The video decoder according to claim 11, wherein the reference picture information updating module calculates the number of short-term reference pictures and the number of long-term reference pictures.

13. The video decoder according to claim 11, wherein the reference picture information updating module removes the short-term reference picture having the smallest POC out of the short-term reference pictures present in the reference picture storage module from the DPB when the number of pictures stored in the reference picture storage module is equal to Max(max_num_ref_frame, 1) and the number of short-term reference pictures is larger than 0.

14. The video decoder according to claim 10, wherein the hierarchical picture structure is a GOP hierarchical picture structure including five temporal layer pictures and eight pictures.

15. The video decoder according to claim 10, wherein the second highest temporal layer picture is a picture present in a third temporal layer and the highest temporal layer picture is a picture present in a fourth temporal layer.

16. A video decoder comprising:
a reference picture information updating module that determines whether the number of pictures calculated on the basis of short-term reference pictures and long-term reference pictures stored in a reference picture storage module so as to include decoded second highest temporal layer pictures is equal to Max(max_num_ref_frame, 1) and determines whether the number of short-term reference pictures is larger than 0; and
a reference picture storage module that updates the reference pictures on the basis of information created by the reference picture information updating unit.

17. The video decoder according to claim 16, wherein the reference picture information updating module calculates the number of short-term reference pictures and the number of long-term reference pictures.

18. The video decoder according to claim 16, wherein the reference picture information updating module updates the reference picture so as to remove the short-term reference picture having the smallest POC out of the short-term reference pictures present in the DPB from the DPB when the number of pictures stored in the DPB is equal to Max(max_num_ref_frame, 1) and the number of short-term reference pictures is larger than 0.
